(19) United States
(12) Patent Application Publication
(10) Pub. No.: US 2025/0202319 A1
(43) Pub. Date: Jun. 19, 2025

(54) DRIVE UNIT OF AN E-BIKE OR PEDELEC, AND E-BIKE OR PEDELEC

(71) Applicant: Porsche eBike Performance GmbH, Ottobrunn (DE)

(72) Inventors: Stephan Happ, Munich (DE); Julius Thorwart, Ottobrunn (DE)

(21) Appl. No.: 18/984,670

(22) Filed: Dec. 17, 2024

(30) Foreign Application Priority Data
Dec. 19, 2023 (DE) 10 2023 135 847.2
Feb. 9, 2024 (DE) 10 2024 103 701.6

(51) Int. Cl. H02K 9/22; B62M 6/55; H02K 7/116

(52) U.S. Cl. CPC H02K 9/227; B62M 6/55; H02K 7/116

(57) ABSTRACT

A drive unit of an e-bike or pedelec has a first sub-unit including a first housing and a pedal crank shaft rotatably mounted in the first housing and a second sub-unit having a second housing and an electric machine received in the second housing. A motor shaft of the electric machine extends perpendicularly to the pedal crank shaft and is operatively connected to the pedal crank shaft via at least one gear stage. At least one separate heat sink extends along the first housing for cooling the first subassembly housing and/or along the second housing for cooling the second sub-unit, the at least separate heat sink being detachably connected to the first housing of the first sub-unit and/or to the second housing of the second sub-unit.

### CROSS-REFERENCE TO THE RELATED APPLICATIONS

This application claims priority of German patent application nos. 10 2023 135 847.2, filed Dec. 19, 2023, and 10 2024 103 701.6, filed Feb. 9, 2024, the entire contents of which are incorporated herein by reference.

### TECHNICAL FIELD

The disclosure relates to a drive unit of an e-bike or pedelec, and to an e-bike or pedelec.

### BACKGROUND

EP 2 731 858 B1 discloses a bicycle configured as an e-bike or pedelec with a drive system. The drive system of the e-bike or pedelec has a pedal crank shaft on which pedal cranks and a chain wheel engage. Furthermore, the drive system has an electric motor that is operatively connected to the pedal crank shaft via at least one gear stage for drive assistance. A motor shaft of the electric motor extends perpendicular to the pedal crank shaft. The electric motor and the at least one gear stage can thus be installed in a down tube of a bicycle frame in a space-saving manner.

FR 3 098 488 A1 discloses another e-bike or pedelec, wherein a drive system of the e-bike or pedelec shown there in turn has a pedal crank shaft, on which a chain wheel and pedal cranks engage, as well as an electric machine. The electric machine is arranged concentrically around the pedal crank shaft. The drive system has a heat sink to cool the electric machine.

DE 10 2013 112 804 A1 discloses a further bicycle configured as an e-bike or pedelec with a drive system. The drive system has a pedal crank shaft on which pedal cranks engage. Furthermore, the drive system has an electric motor-gearbox unit, with the electric motor being arranged concentrically to the pedal crank shaft.

There is a need for an e-bike or pedelec drive unit that also allows effective cooling of the drive unit's components.

In particular, there is a need for an e-bike or pedelec drive unit in which effective cooling of the drive unit's electric machine is possible, namely when the electric machine is not coaxial with the pedal crank shaft, but perpendicular to the pedal crank shaft and, when installed on the bicycle, is at least partially located in a down tube of a bicycle frame.

### SUMMARY

It is an object of the disclosure to create a drive unit for an e-bike or pedelec and an e-bike or pedelec with such a drive unit.

The above object is, for example, achieved by a drive unit of an e-bike or pedelec. The drive unit includes: a first sub-unit having a first housing and a pedal crank shaft rotatably mounted in the first housing; a second sub-unit having a second housing and an electric machine received in the second housing; the electric machine having a motor shaft, the motor shaft extending perpendicular to the pedal crank shaft and being operatively connected to the pedal crank shaft; at least one separate heat sink which extends along at least one of the first housing for cooling the first sub-unit and the second housing for cooling the second sub-unit; and, the at least one separate heat sink being detachably connected to at least one of the first housing of the first sub-unit and the second housing of the second sub-unit.

The above object is, for example, also achieved by an e-bike or pedelec including: a drive unit including a first sub-unit and a second sub-unit; the first sub-unit having a first housing and a pedal crank shaft rotatably mounted in the first housing; the second sub-unit having a second housing and an electric machine received in the second housing; the electric machine having a motor shaft, the motor shaft extending perpendicular to the pedal crank shaft and being operatively connected to the pedal crank shaft; the drive unit further having at least one separate heat sink which extends along at least one of the first housing for cooling the first sub-unit and the second housing for cooling the second sub-unit; and, the at least one separate heat sink being detachably connected to at least one of the first housing of the first sub-unit and the second housing of the second sub-unit.

The drive unit has at least one separate heat sink which extends along the first housing for cooling the first sub-unit and/or extends along the second housing for cooling the second sub-unit. The at least one separate heat sink is detachably connected to the first housing of the first sub-unit and/or to the second housing of the second sub-unit.

In the drive unit according to the disclosure, the at least one separate heat sink extends along the first housing of the first sub-unit of the drive unit and/or along the second housing of the second sub-unit of the drive unit. Since the respective heat sink is configured as a separate component, it can be adapted to the individual requirements of different bicycle frames without the need for changes to other assemblies of the drive unit. The respective heat sink can also be easily replaced with a new heat sink during operation. The new heat sink allows for effective cooling of assemblies of the drive unit, in particular the electric motor of the drive unit.

According to an embodiment of the disclosure, the drive unit includes a single separate heat sink which extends along the first housing for cooling the first sub-unit and which also extends along the second housing for cooling the second sub-unit, wherein the single separate heat sink is detachably connected to the first housing of the first sub-unit and/or to the second housing of the second sub-unit. In this embodiment of the drive unit according to the disclosure, the separate heat sink extends both along the first housing of the first sub-unit of the drive unit and along the second housing of the second sub-unit of the drive unit. Assemblies in the area of the first sub-unit and of the second sub-unit can be cooled effectively, in particular the electric machine of the second sub-unit.

According to an alternative embodiment, the drive unit has a single separate heat sink which extends along the first housing for cooling the first sub-unit and is detachably connected to the first housing of the first sub-unit, or which extends along the second housing for cooling the second sub-unit and is detachably connected to the second housing of the second sub-unit. In this embodiment, the sub-unit of the drive unit along whose housing the separate heat sink does not extend can be assigned a heat sink integrally formed on the respective housing, which can then be thermally coupled and/or connected to the separate heat sink.

According to a further embodiment, the drive unit has a first separate heat sink, which extends along the first housing for cooling the first sub-unit, and a second separate heat sink, which extends along the second housing for cooling the second sub-unit along the second housing, wherein the first separate heat sink is detachably connected to the first housing of the first sub-unit and the second separate heat sink is detachably connected to the second housing of the second sub-unit. In this embodiment, the two separate heat sinks can be thermally coupled and/or interconnected.

According to various embodiments, at least one heat-conducting body is arranged between the respective heat sink and the first housing of the first sub-unit and/or between the respective heat sink and the second housing of the second sub-unit. In particular, the at least one heat-conducting body is pressed between the respective heat sink and the first housing and/or the second housing. This ensures a particularly effective heat transfer from the first housing and/or second housing to the respective heat sink and thus ultimately a particularly effective cooling of the drive unit. Assemblies of the drive unit can be effectively cooled.

According to various embodiments, the respective heat sink has cooling fins on its side facing away from the respective heat-conducting body, the respective heat sink having, on its side facing the respective heat-conducting body, a contour that is adapted to a contour of the respective heat-conducting body its side facing the respective heat-conducting body, and the respective heat-conducting body having, on its side facing the first housing and/or the second housing, a contour that is adapted to a contour of the first housing and/or the second housing. This may be preferred, on the one hand, to enable effective heat transfer from the first housing of the first sub-unit and/or from the second housing of the second sub-unit to the respective heat sink and from the respective heat sink into the environment. Assemblies of the drive unit can be effectively cooled.

According to various embodiments, the side of the respective heat sink facing the respective heat-conducting body has at least one cylinder-segment-like recess in which the respective heat-conducting body engages with a respective cylinder-segment-like projection. This allows a particularly advantageous heat transfer from the respective heat-conducting body to the respective heat sink. Assemblies of the drive unit can be effectively cooled.

According to various embodiments, the heat-conducting body has on its side facing the first housing and/or the second housing at least one cylinder-segment-like recess, in which the first housing and/or the second housing, which are contoured in a cylindrical manner, engage in sections. This allows a particularly favorable heat transfer from the first housing and/or second housing of the two subunits to the heat-conducting body. Assemblies of the drive unit can be effectively cooled.

### BRIEF DESCRIPTION OF DRAWINGS

The invention will now be described with reference to the drawings wherein:

FIG. 1 shows a section of an e-bike or pedelec in the area of a drive unit according to the disclosure in a side view;

FIG. 2 shows the drive unit according to the disclosure in a side view;

FIG. 3 shows a heat sink and heat-conducting body of the drive unit according to the disclosure in a perspective view from above;

FIG. 4 shows the heat-conducting body of the drive unit according to the disclosure in a perspective view from above;

FIG. 5 shows the heat sink of the drive unit according to the disclosure in a perspective view from above;

FIG. 6 shows the heat sink of the drive unit according to the disclosure in a perspective view from below;

FIG. 7 shows a cross-section through FIG. 1 along the line of section VII-VII; and,

FIG. 8 shows a cross-section through FIG. 2 along the line of section VIII-VIII.

### DETAILED DESCRIPTION

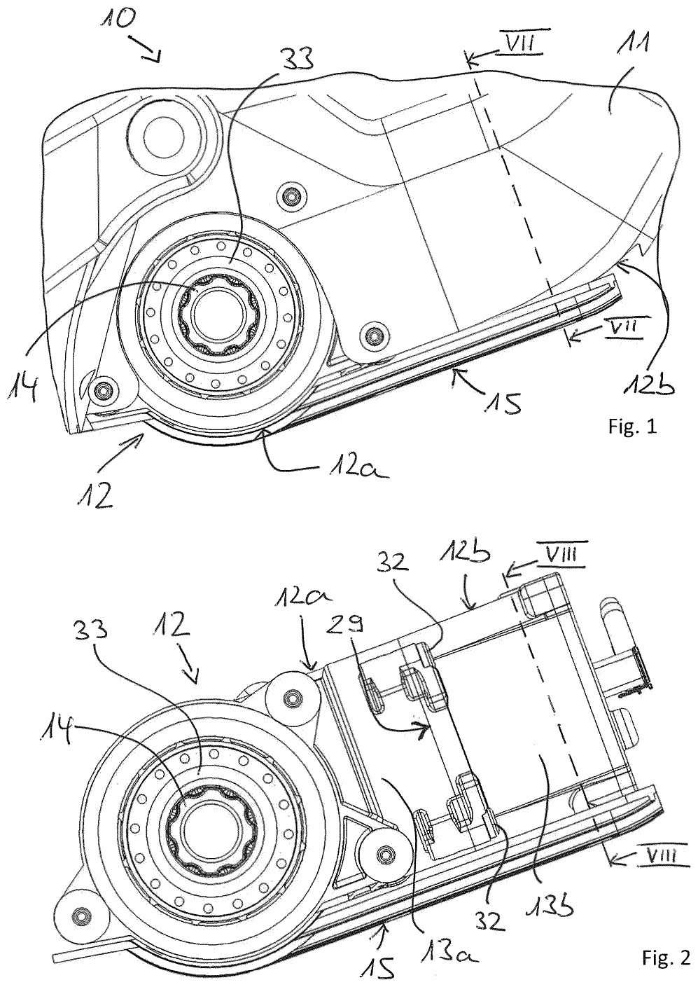

FIG. 1 shows a section of a bicycle 10 configured as an e-bike or pedelec in the area of a frame 11 of the bicycle 10 and a drive unit 12 of the same. In FIG. 2, the drive unit 12 is shown in isolation.

The drive unit 12 has a first sub-unit 12a with a first housing 13a and a second sub-unit 12b with a second housing 13b. The first sub-unit 12a has a pedal crank shaft 14 that is rotatably mounted in the first housing 13a and on which pedal cranks (not shown) and a chain wheel engage. The second sub-unit 12b has an electric machine 30 arranged in the housing 13b of the same, which serves to provide drive assistance for the e-bike or pedelec.

The pedal crank shaft 14 of the first sub-unit 12a runs perpendicular to the drawing plane in FIGS. 1 and 2. A motor shaft 31 of the electric motor 30 runs in FIGS. 1 and 2 in the drawing plane, that is, perpendicular to the pedal crank shaft 14. The longitudinal center axes of the pedal crank shaft 14 and the motor shaft 31 of the electric motor 30, which run perpendicular to each other, can intersect, but can also be at a distance from each other.

The motor shaft 31 of the electric machine 30 is operatively connected to the pedal crank shaft 14 via at least one gear stage (not shown). It is possible that such a gear stage is arranged exclusively in the housing 13b of the second sub-unit 12b or exclusively in the housing 13a of the first sub-unit 12a. It is also possible that a gear stage is arranged in each of the housings 13a, 13b of the two subunits 12a, 12b.

The two housings 13a, 13b of the two subunits 12a, 12b of the drive unit 12 can preferably be connected to each other by screws. In FIG. 2, screws 15 are shown that extend through sections of the two housings 13a, 13 for this purpose.

FIG. 2 shows a parting plane 29 between the two housings 13a, 13 of the two subunits 12a, 12b.

When mounted in the bicycle frame 11, the pedal crank shaft 14 is freely accessible so that it can rotate freely. Portions of the housing 13a and the housing 13b are arranged in the bicycle frame 11, preferably in a down tube thereof.

In the embodiment shown, the drive unit 12 according to the disclosure has a single separate heat sink 15 that extends along the first housing 13a to cool the first sub-unit 12a and along the second housing 13b to cool the second sub-unit 12b, namely on sections of the housings 13a, 13b of the subunits 12a, 12b, which, when installed on the bicycle frame 11, are not covered by the bicycle frame 11 and are therefore accessible from the outside, so that the heat sink 15 can dissipate heat from the housings 13a, 13b of the two subunits 12a, 12b into the environment.

The separate heat sink 15 is detachably connected to the first housing 13a of the first sub-unit 12a and/or to the second housing 13b of the second sub-unit 12b. According to various embodiments, the single separate heat sink 15 is detachably connected to both housings 13a, 13b of both subunits 12a, 12b.

The fact that the heat sink 15 is configured as a separate assembly means that it can be individually adapted to, for example, a bicycle frame 11 without the need for modifications to the other assemblies of the drive unit. Furthermore, the heat sink 15 can easily be replaced by another heat sink.

A single heat-conducting body 16 can preferably be arranged between the heat sink 15 and the first housing 13a of the first sub-unit 12a and between the heat sink 15 and the second housing 13b of the second sub-unit 12b. The heat-conducting body 16 promotes the transfer of heat from the housings 13a, 13b of the two subunits 12a, 12b to the heat sink 15.

The heat-conducting body 16 can be configured as a single part and inserted into the heat sink 15. It is also possible that the heat-conducting body 16 is injection-molded onto the heat sink 15 and thus connected to the same in a materially bonding manner.

The heat-conducting body 16 can preferably be pressed between the heat sink 15 and the housings 13a, 13b of the two subunits 12a, 12b. This pressing is effected when the heat sink 15 is connected to the housings 13a, 13b.

The heat sink 15 has cooling fins 17 on a side facing away from the heat-conducting body 16. The cooling fins 17 allow a particularly advantageous transfer of heat from the heat sink 15 into the environment.

On its side facing the heat-conducting body 16, the heat sink 15 has a contour that is adapted to a contour of the heat-conducting body 16 on its side facing the heat sink 15. This serves to optimally transfer heat from the heat-conducting body 16 to the heat sink 15.

On its side facing the first housing 13a and the second housing 13b of the two subunits 12a, 12b, the heat-conducting body 16 has a contour which is adapted to the contour of the first housing 12a and the second housing 12b, in order to enable optimal heat transfer from the two housings 12a, 12b to the heat-conducting body 16.

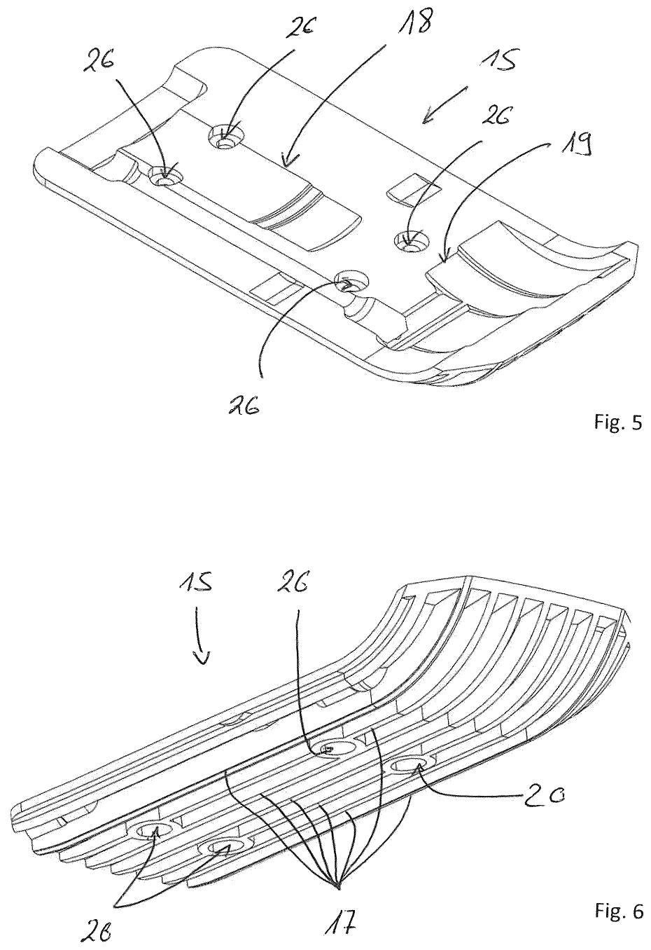

According to FIG. 5, the heat sink 15 has cylinder-segment-like recesses 18, 19 on its side facing the heat-conducting body 16. The heat-conducting body 16 engages with the respective cylinder-segment-like projections 20, 21 in these cylinder-segment-like recesses 18, 19 of the heat sink 15. This allows for a particularly favorable heat transfer from the heat-conducting body 16 to the heat sink 15.

The heat-conducting body 16 has, on its side facing the first housing 12a and the second housing 12b, cylinder-segment-like recesses 22, 23, in which the housings 13a, 13b of the subunits 12a, 12b, which are contoured in a cylindrical manner, engage in sections. This also allows for an optimal heat transfer from the respective housing 13a, 13b of the respective sub-unit 12a, 12b to the heat-conducting body 16.

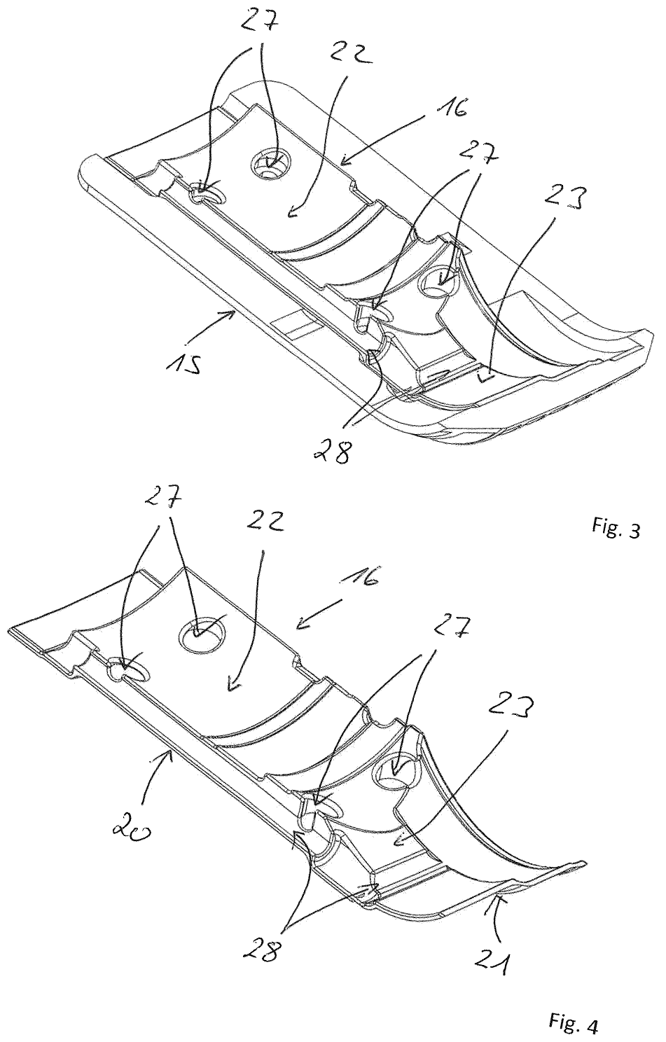

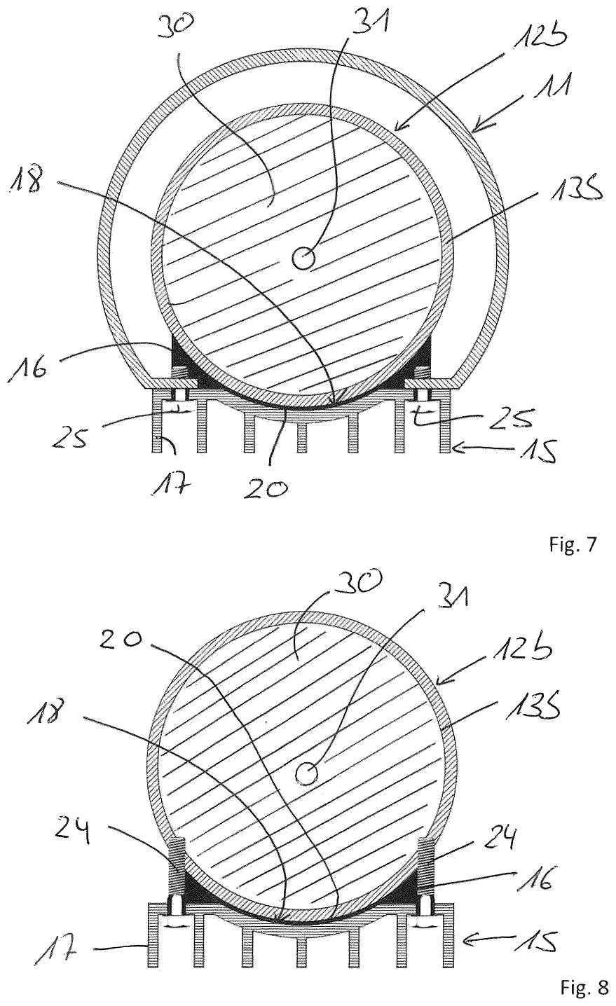

It can be seen from the cross-sections in FIGS. 7 and 8 that the heat sink 15 can be screwed to the housing 13b of the sub-unit 12b via first screws 24 and to the bicycle frame 11, namely to the down tube thereof, via second screws 25. The heat sink 15 can be dismantled and replaced by loosening these screws 24, 25. FIGS. 3 to 6 show recesses 26 in the heat sink 15 and recesses 27 in the heat-conducting body 16 for the passage of the screws 24, 25.

According to various embodiments, the heat sink 15, on its side facing the heat-conducting body 16, and/or the heat-conducting body 16, define receiving spaces 28 for electrical connectors and/or electrical lines. In the embodiment shown, these receiving spaces are defined exclusively by the heat-conducting body 16. This makes it possible to guide and accommodate electrical lines and electrical connectors in a space-saving manner.

The heat-conducting body 16 can preferably be made of a thermoplastic elastomer. However, other materials with good heat-conducting properties can also be used, which can be elastically deformed when the heat sink 15 is connected to the housings 13a, 13b of the subunits 12a, 12b and/or the frame 11, and can thus be pressed.

The two housings 13a, 13b of the two subunits 12a, 12b and the heat sink 15 can preferably consist of a metallic material, but can also consist of hard plastic.

Heat can be dissipated from the drive unit 12 according to the disclosure. The interchangeability of the heat sink 15 allows the drive unit 12 to be individually adapted to different frames without the need to adapt other assemblies of the same. The heat sink 15 can be easily replaced.

As already mentioned, the heat-conducting body 16 can preferably be a body made of a thermoplastic elastomer. Other thermoplastics can also be used to provide the heat-conducting body 16. A heat-conducting body made of a thermoplastic not only provides excellent heat transfer from the housings 13a, 13b of the two subunits 12a, 12b to the heat sink 15, but such a thermoplastic can also provide damping properties and sealing functions. In particular, it can reduce the transmission of structure-borne noise into the heat sink and also into the bicycle frame.

If the heat sink 15 is damaged, it can easily be replaced. If the heat sink 15 is overheated, for example due to a high power requirement from the drive unit, the heat sink 15 can be replaced with a cold heat sink. In this case, the electric motor 30 of the drive unit 12 can then provide a high level of power for drive assistance over a longer period of time.

The configuration of the heat sink 15 as a separate assembly can also simplify the manufacturability of the drive unit 12.

Furthermore, the heat sink 15 and the housings 13a, 13b can be made of different materials. For example, the housings 13a, 13b of the sub-units can be made of a magnesium alloy material and the heat sink can be made of an aluminum alloy material.

Furthermore, due to the fact that the heat sink 15 is configured as a separate assembly, the drive unit 12 can be adapted to the different needs of different OEMs and different bicycle frames by configuring a respective heat sink 15.

In the embodiment shown, the drive unit 12 according to the disclosure has a single separate heat sink 15, which extends along the two housings 13a, 13b to cool the two subunits 12a, 12b and is detachably connected to the two housings 13a, 13b. In the embodiment shown, a single heat-conducting body 16 is arranged between this single heat sink 15 and the housings 13a, 13b.

Alternatively, it is also possible for the drive unit 12 to have a first separate heat sink 15, which extends along the first housing 13a of the first sub-unit 12a for cooling the first sub-unit 12a, and a second separate heat sink 15, which extends along the second housing 13b of the second sub-unit 12b for cooling the second sub-unit 12b extends along the second housing 13b of the second sub-unit 12b, the first separate heat sink 15 being detachably connected to the first housing 13a of the first sub-unit 12a and the second separate heat sink 15 being detachably connected to the second housing 13b of the second sub-unit 12b. In this alternative of the drive unit, the two separate heat sinks 15 can be thermally coupled and/or connected to one another. In this alternative, a first heat-conducting body 16 can preferably be arranged between the first separate heat sink 15 and the first housing 13a and a second heat-conducting body 16 is arranged between the second separate heat sink 15 and the second housing 13a, which is then configured in an analogous manner to the heat-conducting body 16 described above. In particular, the respective heat-conducting body 16 is pressed between the respective heat sink 15 and the respective housing 13a, 13b and has the contours described above on the side facing the respective heat sink 15 and on the side facing the respective housing 13a, 13b.

Furthermore, it is also possible, as an alternative, for the drive unit 12 to have a single separate heat sink 15, which extends along the first housing 13a for cooling the first sub-unit 12a and is detachably connected to the first housing 13a of the first sub-unit 12a, or which extends along the second housing 13b for cooling the second sub-unit 12b and is detachably connected to the second housing 13b of the second sub-unit 12b. In this alternative, the sub-unit of the drive unit 12, along whose housing the separate heat sink 15 does not extend, can be assigned a heat sink integrally formed on the respective housing, which can then be thermally coupled and/or connected to the separate heat sink 15. According to various embodiments, a heat-conducting body 16 is also arranged in this alternative between the respective separate heat sink 15 and the respective housing 13a, 13b, which is then configured in the same way as the heat-conducting body 16 described above.

It is understood that the foregoing description is that of the preferred embodiments of the invention and that various changes and modifications may be made thereto without departing from the spirit and scope of the invention as defined in the appended claims.

1. A drive unit of an e-bike or pedelec, the drive unit comprising:
a first sub-unit having a first housing and a pedal crank shaft rotatably mounted in said first housing;
a second sub-unit having a second housing and an electric machine received in said second housing;
said electric machine having a motor shaft, said motor shaft extending perpendicular to said pedal crank shaft and being operatively connected to said pedal crank shaft;
at least one separate heat sink which extends along at least one of said first housing for cooling said first sub-unit and said second housing for cooling the second sub-unit; and,
said at least one separate heat sink being detachably connected to at least one of said first housing of said first sub-unit and said second housing of said second sub-unit.

2. The drive unit of claim 1, wherein:
said at least one separate heat sink includes only a single separate heat sink which extends along said first housing for cooling said first sub-unit and along said second housing for cooling the second sub-unit; and,
said single separate heat sink being detachably connected to at least one of said first housing of said first sub-unit and said second housing of said second sub-unit.

3. The drive unit of claim 1 further comprising:
a single separate heat sink which extends along said first housing for cooling said first sub-unit or extends along said second housing for cooling said second sub-unit; and,
said single separate heat sink being detachably connected to said first housing of said first sub-unit or to said second housing of said second sub-unit.

4. The drive unit of claim 1 further comprising:
a first separate heat sink which extends along said first housing for cooling said first sub-unit;
a second separate heat sink which extends along said second housing for cooling said second sub-unit;
said first separate heat sink being detachably connected to said first housing of said first sub-unit; and,
said second separate heat sink being detachably connected to said second housing of said second sub-unit.

5. The drive unit of claim 1 further comprising:
at least one heat-conducting body arranged at least at one of:
between said at least one separate heat sink and said first housing of the first sub-unit, and,
between said at least one separate heat sink and said second housing of said second sub-unit.

6. The drive unit of claim 5, wherein said at least one heat-conducting body is injection molded onto the respective one of said at least one heat sink.

7. The drive unit of claim 5, wherein said at least one heat-conducting body is pressed between the respective one of said at least one separate heat sink and at least one of said first housing and said second housing.

8. The drive unit of claim 5, wherein:
said at least one separate heat sink has cooling ribs on a side of said at least one separate heat sink facing away from said at least one heat-conducting body;
said at least one separate heat sink has, on a side facing said at least one heat-conducting body, a contour adapted to a contour of said at least one heat-conducting body on a side facing said at least one heat sink; and,
said at least one heat-conducting body has, on a side facing at least one of said first housing and the second housing, a contour matched to a contour of a corresponding one of at least one of said first housing and said second housing.

9. The drive unit of claim 8, wherein said at least one separate heat sink has, on the side facing said at least one heat-conducting body, at least one cylinder-segment-like segment-like recess, into which said at least one heat-conducting body projects via a respective cylinder-segment-like projection.

10. The drive unit of claim 8, wherein said heat-conducting body, on at least one of the side facing said first housing and the side facing said second housing, has at least one cylinder-segment-like recess, in which a corresponding one of said first housing and said second housing, which are contoured in a cylinder-like manner, engage in sections.

11. The drive unit of claim 5, wherein at least one of said separate heat sink and said heat-conducting body delimit a receiving space for at least one of an electrical connection and an electrical line.

12. The drive unit of claim 5, wherein said heat-conducting body is made of a thermoplastic elastomer.

13. The drive unit of claim 1, wherein said first housing of said first sub-unit, said second housing of said first sub-unit and said at least one separate heat sink are made of a metallic material or a hard plastic.

14. The drive unit of claim 1, wherein:
said motor shaft of said electric machine is operatively connected to said pedal crank shaft via at least one gear stage; and,
said at least one gear stage is arranged exclusively in said first housing of said first sub-unit; or,
said at least one gear stage is arranged exclusively in said second housing of said second sub-unit; or,
said at least one gear stage includes a first gear stage arranged in said first housing of said first sub-unit and said at least one gear stage includes a second gear stage arranged in said second housing of said second sub-unit.

15. An e-bike or pedelec comprising:
a drive unit including a first sub-unit and a second sub-unit;
said first sub-unit having a first housing and a pedal crank shaft rotatably mounted in said first housing;
said second sub-unit having a second housing and an electric machine received in said second housing;
said electric machine having a motor shaft, said motor shaft extending perpendicular to said pedal crank shaft and being operatively connected to said pedal crank shaft;
said drive unit further having at least one separate heat sink which extends along at least one of said first housing for cooling said first sub-unit and said second housing for cooling the second sub-unit; and,
said at least one separate heat sink being detachably connected to at least one of said first housing of said first sub-unit and said second housing of said second sub-unit.
